(19) United States
(12) Patent Application Publication
(10) Pub. No.: US 2013/0269392 A1
(43) Pub. Date: Oct. 17, 2013

(54) PROCESS FOR PRODUCING CHEMICALLY TEMPERED GLASS

(71) Applicant: ASAHI GLASS COMPANY, LIMITED, Chiyoda-ku (JP)

(72) Inventors: Kazutaka ONO, Chiyoda-ku (JP); Shusaku Akiba, Chiyoda-ku (JP)

(21) Appl. No.: 13/914,058

(22) Filed: Jun. 10, 2013

Related U.S. Application Data
(63) Continuation of application No. PCT/JP2011/078598, filed on Dec. 9, 2011.

(30) Foreign Application Priority Data
Dec. 10, 2010 (JP) 2010-275791

(51) Int. Cl. C03C 21/00

(52) U.S. Cl. CPC C03C 21/002
USPC 65/30.14

(57) ABSTRACT

To provide a process for producing a chemically tempered glass whereby it is possible to increase the surface compressive stress. A process for producing a chemically tempered glass, which comprises holding a glass at a temperature of at least the strain point minus 40° C. and at most the strain point plus 70° C. for at least 30 minutes for heat treatment, and thereafter, immersing it in a molten salt for ion exchange without allowing the temperature to exceed the strain point plus 70° C.

### TECHNICAL FIELD

The present invention relates to a process for producing a chemically tempered glass to be used for a cover glass for e.g. display devices, such as mobile devices such as cell phones or personal digital assistance (PDA), touch panels, and large-sized flat-screen televisions such as large-sized liquid crystal televisions.

### BACKGROUND ART

In recent years, for display devices such as mobile devices such as PDA, touch panels, liquid crystal televisions, etc., a cover glass (protective glass) or chassis has been used or proposed in many cases to protect the display or to improve the appearance.

For such display devices, weight reduction and thickness reduction are required for differentiation by a flat design or for reduction of the load for transportation. Therefore, a cover glass to be used for protecting a display is also required to be made thin. However, if the thickness of the cover glass is made thin, the strength decreases, and there has been a problem such that the cover glass itself is broken by e.g. a shock due to a falling or flying object in the case of an installed type or by dropping during the use in the case of a portable device, and the cover glass cannot perform the essential role to protect the display device.

In order to solve the above problem, it is conceivable to improve the strength of the cover glass, and as such a method, a method to form a compressive stress layer on a glass surface is commonly known.

The method to form a compressive stress layer on a glass surface, may typically be an air quenching tempering method (physical tempering method) wherein a surface of a glass plate heated to near the softening point is quenched by air cooling or the like, or a chemical tempering method wherein alkali metal ions having a small ion radius (typically Li ions or Na ions) at a glass plate surface are exchanged with alkali ions having a larger ion radius (typically K ions) by ion exchange at a temperature lower than the glass transition point.

As mentioned above, the thickness of the cover glass is required to be thin. However, if the air quenching tempering method is applied to a thin glass plate having a thickness of less than 2 mm, as required for a cover glass, the temperature difference between the surface and the inside tends not to arise, and it is thereby difficult to form a compressive stress layer, and the desired property of high strength cannot be obtained. Therefore, a cover glass tempered by the latter chemical tempering method is usually used.

As such a cover glass, one having soda lime glass chemically tempered is widely used (e.g. Patent Document 1).

Soda lime glass is inexpensive and has a feature that the surface compressive stress S of a compressive stress layer formed at the surface of the glass by the chemical tempering can be made to be at least 550 MPa, but there has been a problem that it has been difficult to make the thickness t of the compressive stress layer to be at least 30 μm.

Therefore, one having SiO₂—Al₂O₃—Na₂O type glass different from soda lime glass, chemically tempered, has been proposed for such a cover glass (e.g. Patent Documents 2 and 3).

Such SiO₂—Al₂O₃—Na₂O type glass has a feature that it is possible not only to make the above S to be at least 550 MPa but also to make the above t to be at least 30 μm.

### PRIOR ART DOCUMENTS

### Patent Documents

Patent Document 1: JP-A-2007-11210

Patent Document 2: U.S. Patent Application Publication No. 2009/0298669

Patent Document 3: U.S. Patent Application Publication No. 2008/0286548

### DISCLOSURE OF INVENTION

### Technical Problem

It is highly possible that a mobile device is dropped from the user's hand, pocket or bag and its cover glass gets flaws (indentations), or the dropped mobile device may be stepped on or the user may sit on the mobile device put in the pocket, and a heavy load may thereby be applied to the cover glass in many cases.

A flat screen television such as a liquid crystal television or a plasma television, particularly a large-sized flat screen television having a size of at least 20 inches, is likely to have flaws since its cover glass has a large size, and as the screen is large, the probability of breakage from the flaws as the breakage origin is high. Further, when a flat screen television is used as hung on the wall, it may fall down, and in such a case, a large load may be applied to the cover glass.

A touch panel is likely to have flaws such as scratches at the time of its use.

As such large or small display devices are used more widely now, the number of incidences of breakage of the cover glass itself is increased as compared with the past when the number of use was small or limited.

It is an object of the present invention to provide a process for producing chemically tempered glass, whereby it is possible to increase the surface compressive stress of chemically tempered glass and to prevent breakage of the glass.

### Solution to Problem

The present invention provides a process for producing a chemically tempered glass, which comprises holding a glass at a temperature of at least the strain point minus 40° C. and at most the strain point plus 70° C. for at least 30 minutes for heat treatment, and thereafter, immersing it in a molten salt for ion exchange without allowing the temperature to exceed the strain point plus 70° C.

Further, the present invention provides a process for producing a chemically tempered glass, which comprises holding a glass at a temperature of at least the strain point minus 30° C. and at most the strain point plus 50° C. for at least 30 minutes for heat treatment, and thereafter, immersing it in a molten salt for ion exchange without allowing the temperature to exceed the strain point plus 50° C.

Further, the present invention provides the above process for producing a chemically tempered glass, wherein the surface compressive stress of the chemically tempered glass is at least 550 MPa.

Further, the present invention provides the above process for producing a chemically tempered glass, wherein the glass comprise, as represented by mole percentage based on the following oxides, from 50 to 80% of SiO₂, from 0.5 to 20% of Al₂O₃, from 5 to 20% of Na₂O and from 1 to 20% of MgO, provided that the total content of SiO₂ and Al₂O₃ is from 51 to 85%. The glass having such a composition will be referred to as the glass of the present invention.

Further, the present invention provides the above process for producing a chemically tempered glass, wherein the content of Al₂O₃ in the glass is at least 3%.

Further, the present invention provides the above process for producing a chemically tempered glass, wherein the glass is a glass plate produced by a downdraw process or a float process, or one obtained by processing such a glass plate.

Further, the present invention provides the above process for producing a chemically tempered glass, wherein the thickness of the chemically tempered glass is at most 1.2 mm.

Further, the present invention provides the above process for producing a chemically tempered glass, wherein the chemically tempered glass is one to be used for a cover glass for a display device.

Further, the present invention provides the above process for producing a chemically tempered glass, wherein the display device is a mobile device, a touch panel or a flat-screen television having a size of at least 20 inches.

Heretofore, with respect to e.g. a cover glass, chemical treatment used to be carried out by immersing, in a molten salt, a glass plate produced by a downdraw method or a float method, or one having such a glass plate processed by e.g. grinding or polishing as the case requires.

However, the present inventors have found that by carrying out heat treatment of holding a glass at a temperature of at least the strain point minus 30° C. and at most the strain point plus 50° C. for at least 30 minutes before carrying out chemical treatment, the surface compressive stress can be increased as compared with a case where no such heat treatment is carried out, and further that by carrying out heat treatment of holding a glass at a temperature of at least the strain point minus 40° C. and at most the strain point plus 70° C. for at least 30 minutes before carrying out chemical treatment, the surface compressive stress can be increased as compared with a case where no such heat treatment is carried out, and thus have arrived at the present invention. Here, in a case where the heat treatment comprises, for example, two heat treatments of once holding the glass within a temperature range of at least the strain point minus 30° C. and at most the strain point plus 50° C., followed by a temperature-fall and then again holding the glass within the temperature range, followed by a temperature-fall again, the period of time for holding a glass e.g. at a temperature of at least the strain point minus 30° C. and at most the strain point plus 50° C., is the sum of the periods of time for holding the glass within the temperature range in such two heat treatments.

The mechanism for such a phenomenon to occur is considered to be as follows. That is, by the heat treatment of the glass, structural relaxation takes place, whereby the structure of the glass becomes dense. As a result, it is considered that the volume in the glass occupied by sodium ions becomes small, whereby a strain caused by ion exchange with potassium ions becomes large to increase the surface compressive stress. However, if the glass thereafter becomes to have a temperature exceeding the strain point plus 70° C., its structure tends to be coarse, whereby the effects of the present invention will be lost. Therefore, once the heat treatment of the present invention has been done, the temperature of the glass should not be made to exceed the strain point plus 70° C.

Such a phenomenon is considered to occur essentially irrespective of the composition of glass, since it is one caused by the relaxation characteristics of glass.

### Advantageous Effects of Invention

According to the present invention, it is possible to obtain a chemically tempered glass having a larger surface compressive stress even by using the same glass.

The increase in the surface compressive stress is typically at least 10 MPa, preferably at least 30 MPa. Here, the increase being less than 5 MPa cannot be regarded as showing a substantial increase in the surface compressive stress.

### DESCRIPTION OF EMBODIMENTS

The surface compressive stress S of the chemically tempered glass obtainable by the present invention (hereinafter referred to as the tempered glass of the present invention) is preferably at least 550 MPa, and it is typically at most 1,200 MPa. If S is less than 550 MPa, such a glass tends to be hardly useful as a cover glass, and S is preferably at least 650 MPa.

The thickness t of the compressive stress of the tempered glass of the present invention is preferably more than 20 μm, and it is typically at most 70 μm.

In the heat treatment of the present invention, the temperature for heating the glass is at least the strain point minus 40° C., preferably at least the strain point minus 30° C., more preferably at least the strain point minus 20° C., in order to let relaxation of the glass sufficiently occur. On the other hand, if the temperature for heating the glass is too high, the structure relaxation tends to proceed too much to obtain the desired surface compressive stress, or deformation is likely to occur e.g. when a plate glass is chemically tempered. Therefore, the upper limit of the above heat treatment temperature should be at most the strain point plus 70° C., preferably at most the strain point plus 65° C., more preferably at most the strain point plus 60° C., further preferably at most the strain point plus 50° C.

Further, if the period of time for holding the glass at the above temperature is insufficient, the glass is cooled without reaching the relaxation state required to obtain a high surface compressive stress, and the improvement in the surface compressive stress value tends to be insufficient. Therefore, the holding time is set to be at least 30 minutes, preferably at least 40 minutes, more preferably at least 1 hour.

The molten salt to be used in the present invention is suitably selected for use without any particular restriction, but for example in a case where Na ions in the glass are to be ion exchanged with K ions in the molten salt, a molten salt of potassium nitrate (KNO₃) is usually employed.

The ion exchange conditions to form a chemically tempered layer (compressive stress layer) having a desired surface compressive stress in the glass, may vary depending upon e.g. the thickness of the glass, but are typically such that a glass substrate is immersed in a KNO₃ molten salt at from 350 to 550° C. for from 2 to 20 hours. From the economical viewpoint, it is preferred to carry out the immersion under conditions of from 350 to 500° C. for from 2 to 16 hours, and more preferably the immersion time is from 2 to 10 hours.

In a case where a glass plate being the tempered glass of the present invention is to be used as a cover glass for a display device, its thickness is typically from 0.3 to 2 mm.

In the present invention, the process for producing the glass plate is not particularly limited, however, for example, various raw materials may be mixed in proper amounts, heated and melted at from about 1,400 to 1,700° C., then homogenized by degassing, stirring, etc., formed into a plate-form by means of a well-known float process, down draw process, press process, etc., annealed and then cut into a desired size to obtain the glass plate.

The strain point of the glass to be used in the present invention is preferably at least 400° C. If the strain point is less than 400° C., when it is attempted to carry out ion exchange by means of a KNO₃ molten salt, it tends to be difficult to make the compressive stress layer to be thick. It is more preferably at least 500° C., typically at least 530° C.

Now, the composition of the glass of the present invention will be described by using contents as represented by mole percentage unless otherwise specified.

SiO₂ is a component to constitute a glass matrix and is essential. If the SiO₂ content is less than 50%, devitrification of the glass tends to increase, whereby it tends to be difficult to obtain a glass of high quality. The SiO₂ content is preferably at least 55%, more preferably at least 58%. On the other hand, if SiO₂ is too much, the viscosity of the glass tends to be too high, and refinement during the melting tends to be difficult, whereby it becomes possible only to obtain a glass of low quality. SiO₂ is preferably at most 78%.

Al₂O₃ is a component to increase the weather resistance and to improve the chemical tempering performance, particularly the depth of the stress layer, and thus is essential. If it is less than 0.5%, the above mentioned t tends to be small, whereby the required strength tends to be hardly obtainable. Al₂O₃ is preferably at least 4%, more preferably at least 4.5%. On the other hand, if Al₂O₃ is too much, the viscosity of the glass melt tends to be high, and refinement tends to be difficult, whereby it becomes possible only to obtain a glass of low quality. Al₂O₃ is preferably at most 10%, more preferably at most 9%.

If the total content of SiO₂ and Al₂O₃, i.e. SiO₂+Al₂O₃, is less than 51%, the stability of the glass tends to decrease, and devitrification tends to occur. If the total content exceeds 85%, the viscosity of the glass melt tends to be too high, and melting of the glass tends to be difficult.

Na₂O is a component to form a surface compressive stress layer by ion exchange and to improve the melting property of the glass, and is essential. If the Na₂O content is less than 5%, it tends to be difficult to impart a desired surface compressive stress by ion exchange, and it is preferably at least 8%. If Na₂O exceeds 20%, the weather resistance of the glass tends to decrease, and it is preferably at most 18%.

K₂O is not essential but may be contained up to 15%, since it improves the melting property and increases the ion exchange rate. If K₂O exceeds 15%, the above mentioned S tends to decrease, and it is preferably at most 10%, more preferably at most 6%.

MgO is a component to lower the viscosity of the glass without impairing the chemical tempering properties and to improve the melting property, and thus is essential. If MgO exceeds 20%, the glass tends to be devitrified, and it is preferably at most 18%.

ZrO₂ is not essential, but may be contained within a range of up to 7%, since it is a component to lower the viscosity at a high temperature or to improve the melting property. If ZrO₂ exceeds 7%, devitrification tends to occur, and it is preferably at most 5%.

ZnO is not essential, but may be contained e.g. up to 2% in some cases to improve the melting property at a high temperature of the glass, and it is preferably at most 1%. In a case where a float process is used for the production, ZnO is preferably at most 0.5%. If ZnO exceeds 0.5%, reduction is likely to take place during the float forming, thus leading to a product defect. Typically no ZnO is contained.

B₂O₃ is not essential, but may be contained within a range of e.g. less than 1% in some cases, in order to improve the melting property at a high temperature and the glass strength. If B₂O₃ is at least 1%, homogeneous glass tends to be hardly obtainable, and the glass forming may be difficult, or the chipping resistance may deteriorate. It is preferably less than 0.5%. Typically no B₂O₃ is contained.

CaO is not essential, but may be contained within a range of less than 15%, since it is a component to improve the melting property at a high temperature or to prevent devitrification. If the CaO content is too much, the devitrification property of the glass tends to be increased. CaO is preferably at most 10%, more preferably at most 9%.

SrO is not essential, but may be contained as the case requires. However, as compared with MgO or CaO, it has a large effect to lower the ion exchange rate, and therefore, even when it is contained, its content is preferably less than 8%. Typically no SrO is contained.

BaO is not essential, but may be contained in some cases for stabilization of the glass. However, among the alkaline earth metal oxides, it has the largest effect to lower the ion exchange rate, and it is preferred that BaO is not contained, or even if it is contained, its content is less than 8%.

In a case where SrO and/or BaO is contained, their total content is preferably at most 12%, more preferably less than 10%.

In a case where at least one of CaO, SrO, BaO and ZrO₂ is contained, the total content of the four components is preferably less than 20%. If the total content is 20% or higher, the ion exchange rate tends to decrease. Typically the total content is at most 15%.

The glass of the present invention consists essentially of the above-described components, but may contain other components within a range not to impair the objects of the present invention. When it contains such other components, the total content of such other components is preferably at most 5%, typically at most 3%.

As a refining agent at the time of melting glass, SO₃, a chloride, a fluoride or the like may suitably be contained. However, in a case where it is desired to increase the visibility of display devices such as touch panels, it is preferred to reduce components which may be included as impurities in raw materials such as Fe₂O₃, NiO, Cr₂O₃, etc. having an absorption in a visible light range as far as possible, and the content of each of them is preferably at most 0.15%, more preferably at most 0.05%, as represented by mass percentage.

Further, TiO₂ is likely to deteriorate the visible light transmittance and to color glass to be brown when it is coexistent with Fe ions in the glass, and therefore, in a case where coloration is not desired, its content is preferably at most 1% if contained, and typically, it is not contained.

The glass of the present invention is a glass suitable for chemical tempering. In consideration of the mechanism to improve the compressive stress to bring about the effects of the present invention, a glass to be used for the present invention is not limited to the above described glass of the present invention, and the composition of glass to be chemically tempered in the present invention, may suitably be selected depending on e.g. the particular application of the tempered glass of the present invention.

### EXAMPLES

### Example 1

Raw materials were weighed so that 400 g of glass with a composition comprising, as represented by mole percentage, 73% of SiO₃, 7% of Al₂O₃, 6% of MgO and 14% of Na₂O, would be obtained. To the entirety of such weighted raw materials, sodium sulfate was added in a mass corresponding to 0.2% based on the total mass of these raw materials, followed by mixing. Then, the mixed raw materials were put into a crucible made of platinum, introduced into an electric resistance heating furnace at 1,650° C., melted for 5 hours, degassed and homogenized. The obtained molten glass was cast into a mold material and held at a temperature of 670° C. for one hour, and then cooled to room temperature at a rate of 0.5° C./min. to obtain a glass block. This glass block was cut and ground, and finally both surfaces were mirror-polished to obtain a glass plate having a size of 20 mm×20 mm and a thickness of 1.2 mm. Further, the glass transition temperature Tg of this glass is 617° C., and the strain point thereof is 556° C.

This glass plate was heated at a rate of 10° C./min. and held at a temperature of 650° C. for one hour, and then cooled to room temperature at a rate of 100° C./min. to obtain a quenched glass plate.

This quenched glass plate was immersed in a KNO₃ molten salt (KNO₃: 100%) at 425° C. for 10 hours to carry out chemical tempering treatment. With respect to the glass plate after the chemical tempering treatment, the surface compressive stress S and the compressive stress layer depth t were measured by means of surface stress meter FSM-6000 manufactured by Orihara Manufacturing Co., Ltd. and found to be 660 MPa and 48 μm, respectively.

Further, with respect to the quenched glass plate, heat treatment of holding it at a heat treatment temperature of 540° C. or 550° C. (hereinafter sometimes represented by θ) for 1, 2 or 4 hours, was carried out. Here, the temperature was raised at a rate of 5° C./min., and the glass plate was cooled from θ to a temperature of θ minus 150° C. at a rate of 0.5° C./min. and thereafter naturally cooled to room temperature (during the natural cooling, the cooling rate to 200° C. was higher than 1° C./min.). Further, in the process of the temperature rise to θ and the cooling from θ, the total period of time where the glass plate was held at a temperature of at least the strain point minus 30° C. and at most the strain point plus 50° C., was about 60 minutes, the total period of time where the glass plate was held at a temperature of at least the strain point minus 40° C. and at most the strain point plus 70° C., was about 80 minutes, and the total period of time where the glass plate was held at a temperature of at least the strain point minus 45° C. and at most the strain point plus 70° C., was about 91 minutes.

With respect to the heat-treated glass plate thus obtained, the same chemical tempering treatment as described above was carried out, and S and t were measured. θ (unit: ° C.) in the above heat treatment and the time H (unit: hr) for holding the glass plate at θ as well as S (unit: MPa) and t (unit: μm), are shown in Table 1 together with the difference ΔS (unit: MPa) between S and S in a case where the above heat treatment was not conducted i.e. 660 MPa.

From Table 1, it is evident that when the quenched glass plate was subjected to the above heat treatment, the surface compressive stress increased. Especially, by the heat treatment at 550° C. for 4 hours, the surface compressive stress increased by at least 100 MPa. Here, the heat treatment was conducted at a relatively low temperature of from 540 to 550° C., whereby no warpage of the glass plate was observed.

TABLE 1

| ⊖ | H | S | t | ΔS |
|---|---|---|---|---|
| 540 | 1 | 709 | 46 | 49 |
| 540 | 2 | 731 | 46 | 71 |
| 540 | 4 | 740 | 45 | 80 |
| 550 | 1 | 718 | 46 | 58 |
| 550 | 2 | 739 | 45 | 79 |
| 550 | 4 | 771 | 44 | 111 |

### Example 2

A float glass with a composition comprising, as represented by mole percentage, 73% of SiO₃, 7% of Al₂O₃, 6% of MgO and 14% of Na₂O and a thickness of 1.3 mm, was prepared.

This float glass was cut and ground, and finally both surfaces were mirror-polished to obtain a glass plate having a size of 20 mm×20 mm and a thickness of 1.0 mm. Here, the glass transition temperature Tg of this glass is 617° C., and the strain point thereof is 556° C. The total period of time where the glass was held at a temperature of at least the strain point minus 30° C. and at most the strain point plus 50° C., was about 2 minutes, and the total period of time where the glass was held at a temperature of at least the strain point minus 45° C. and at most the strain point plus 70° C., was about 3 minutes.

With respect to this glass plate, chemical tempering treatment of immersing it in a KNO₃ molten salt (KNO₃: 100%) at 410° C. for 13 hours was carried out. S and t of the chemically tempered glass were measured and found to be 686 MPa and 50 μm, respectively.

Further, as shown in Table 2, the above glass plate having a size of 20 mm×20 mm and a thickness of 1.0 mm was subjected to heat treatment of holding it at a heat treatment temperature θ of 550° C. or 570° C. for 4 or 8 hours.

Here, the temperature was raised at a rate of 5° C./min., and the glass plate was cooled from θ to a temperature of θ minus 150° C. at a rate of 0.5° C./min. and thereafter naturally cooled to room temperature (during the natural cooling, the cooling rate to 200° C. was higher than 1° C./min.). Accordingly, in the process of the temperature rise to θ and the cooling from θ, the period of time where the glass plate was held at a temperature of at least the strain point minus 30° C. and at most the strain point plus 50° C., was about 60 minutes in total in the case where θ was 550° C., or about 100 minutes in total in the case where θ was 570° C., the period of time where the glass plate was held at a temperature of at least the strain point minus 40° C. and at most the strain point plus 70° C., was about 80 minutes in total in the case where θ was 550° C., or about 120 minutes in total in the case where θ was 570° C., and the period of time where the glass plate was held at a temperature of at least the strain point minus 45° C. and at most the strain point plus 70° C., was about 90 minutes in total in the case where θ was 550° C., or about 130 minutes in total in the case where θ was 570° C.

With respect to such a heat-treated glass plate, chemical tempering treatment of immersing it in a KNO₃ molten salt (KNO₃: 100%) at 410° C. for 13 hours, was conducted. S and t of the glass subjected to such chemical tempering treatment, were measured. The results are shown in Table 2 together with ΔS. In each glass plate, an improvement of S by from 87 to 116 MPa was observed as compared with S=686 MPa of the glass plate which was not subjected to heat treatment.

TABLE 2

| ⊖ | H | S | t | ΔS |
|---|---|---|---|---|
| 550 | 4 | 773 | 43 | 87 |
| 550 | 8 | 798 | 43 | 112 |
| 570 | 4 | 802 | 44 | 116 |

### Example 3

A float glass with a composition comprising, as represented by mole percentage, 73% of SiO₃, 7% of Al₂O₃, 6% of MgO and 14% of Na₂O and a thickness of 1.3 mm, was prepared.

This float glass was cut and ground, and finally both surfaces were mirror-polished to obtain a glass plate having a size of 20 mm×20 mm and a thickness of 1.0 mm. Further, the glass transition temperature Tg of this glass is 617° C., and the strain point thereof is 556° C. The period of time where the glass was held at a temperature of at least the strain point minus 30° C. and at most the strain point plus 50° C., was about 2 minutes.

With respect to this glass plate, chemical tempering treatment was carried out under various conditions. That is, chemical tempering treatment was carried out by adjusting the content of Na in the KNO₃ molten salt to be 0 ppm, 1,350 ppm, 2,700 ppm, 5,400 ppm or 13,500 ppm, the temperature of the molten salt to be 400° C., 420° C. or 450° C. and the time for immersion in the molten salt to be 6 hours or 10 hours.

With respect to the glass plate subjected to such chemical tempering treatment, S and t were measured. The results are shown in the columns for S₀ (unit: MPa) and t₀ (unit: μm) in Table 3. In the Table, “Na” represents the content (unit: ppm) of Na in the KNO₃ molten salt, “Tc” represents the temperature (unit: ° C.) of the molten salt, and “Hc” represents the time (unit: hr) for immersion in the molten salt.

Further, with respect to the above glass plate having a size of 20 mm×20 mm and a thickness of 1.0 mm, heat treatment was carried out so that the temperature was raised at a rate of 10° C./min., and it was held at a temperature of 550° C. for 4 hours, then cooled at a rate of 0.5° C./min to 400° C. and then naturally cooled to room temperature (during the natural cooling, the cooling rate to 200° C. was higher than 1° C./min.). Further, in the process of the temperature rise to 550° C. and the cooling from 550° C., the period of time where the glass plate was held at a temperature of at least the strain point minus 30° C. and at most the strain point plus 50° C., was about 60 minutes in total, the period of time where the glass plate was held at a temperature of at least the strain point minus 40° C. and at most the strain point plus 70° C., was about 80 minutes in total, and the period of time where the glass plate was held at a temperature of at least the strain point minus 45° C. and at most the strain point plus 70° C., was about 90 minutes in total.

Also with respect to the glass plate subjected to such heat treatment, chemical tempering treatment was carried out under various conditions as mentioned above, and S and t were measured. The results are shown in the columns for S (unit: MPa) and t (unit: μm) in Table 3. Further, ΔS (unit: MPa) in Table 3 is the difference between this S and the above-mentioned S₀.

ΔS is from 43 to 96 MPa irrespective of chemical tempering treatment conditions, and it is evident that also in the case of a glass produced by a float process, the surface compressive stress can be increased by carrying out the heat treatment of the present invention.

TABLE 3

| Tc | Na | Hc | S₀ | t₀ | S | t | ΔS |
|---|---|---|---|---|---|---|---|
| 400 | 0 | 6 | 788 | 27 | 845 | 24 | 57 |
| 400 | 1350 | 6 | 753 | 26 | 823 | 23 | 70 |
| 400 | 2700 | 6 | 746 | 27 | 808 | 24 | 62 |
| 400 | 5400 | 6 | 704 | 27 | 767 | 24 | 63 |
| 400 | 13500 | 6 | 624 | 27 | 667 | 23 | 43 |
| 400 | 0 | 10 | 761 | 35 | 823 | 31 | 62 |
| 400 | 1350 | 10 | 722 | 36 | 797 | 31 | 75 |
| 400 | 2700 | 10 | 705 | 35 | 790 | 32 | 85 |
| 400 | 5400 | 10 | 675 | 36 | 762 | 32 | 87 |
| 400 | 13500 | 10 | 612 | 34 | 673 | 31 | 61 |
| 420 | 0 | 6 | 710 | 36 | 794 | 33 | 84 |
| 420 | 1350 | 6 | 686 | 36 | 771 | 31 | 85 |
| 420 | 2700 | 6 | 673 | 36 | 769 | 31 | 96 |
| 420 | 5400 | 6 | 650 | 37 | 730 | 32 | 80 |
| 420 | 13500 | 6 | 594 | 35 | 655 | 32 | 61 |
| 420 | 0 | 10 | 675 | 47 | 762 | 41 | 87 |
| 420 | 1350 | 10 | 658 | 46 | 745 | 41 | 87 |
| 420 | 2700 | 10 | 643 | 47 | 721 | 41 | 78 |
| 420 | 5400 | 10 | 615 | 49 | 699 | 42 | 84 |
| 420 | 13500 | 10 | 576 | 44 | 644 | 39 | 68 |
| 450 | 0 | 6 | 599 | 55 | 664 | 49 | 65 |
| 450 | 1350 | 6 | 579 | 53 | 658 | 48 | 79 |
| 450 | 2700 | 6 | 561 | 56 | 641 | 49 | 80 |
| 450 | 5400 | 6 | 533 | 57 | 598 | 51 | 65 |
| 450 | 13500 | 6 | 519 | 50 | 603 | 44 | 84 |
| 450 | 0 | 10 | 557 | 69 | 617 | 66 | 60 |
| 450 | 1350 | 10 | 539 | 70 | 614 | 66 | 55 |
| 450 | 2700 | 10 | 521 | 71 | 590 | 66 | 69 |
| 450 | 5400 | 10 | 502 | 71 | 597 | 62 | 95 |
| 450 | 13500 | 10 | 497 | 67 | 566 | 58 | 69 |

### Example 4

A float glass with a composition comprising, as represented by mole percentage, 66% of SiO₃, 9% of Al₂O₃, 8.5% of MgO, 12.5% of Na₂O and 4.0% of K₂O and a thickness of 1.1 mm, was prepared.

This float glass was cut and ground, and finally both surfaces were mirror-polished to obtain a glass plate having a size of 30 mm×30 mm and a thickness of 1.0 mm. Here, the glass transition temperature Tg of this glass is 604° C., and the strain point thereof is 556° C. The period of time where the glass was held at a temperature of at least the strain point minus 40° C. and at most the strain point plus 70° C., was about 2 minutes.

With respect to this glass plate, chemical tempering treatment of immersing it in a KNO₃ molten salt (KNO₃: 100%) at 435° C. for 4 hours was carried out. S and t of the chemically tempered glass were measured and found to be 780 MPa and 44 μm, respectively.

The above glass plate having a size of 30 mm×30 mm and a thickness of 1.0 mm was subjected to heat treatment of holding it at a temperature (unit: ° C.) represented by θ in Table 4 for a time (unit: hr) represented by H.

In the heat treatment of holding the glass plate at a heat treatment temperature of 546° C. for 20 minutes and 4 hours, the temperature was raised to the heat treatment temperature θ at a rate of 5° C./min., and the glass plate was cooled from θ to room temperature at a rate of 10° C./min. Accordingly, in the process of the temperature rise to θ and the cooling from θ, the period of time where the glass plate was held at a temperature of at least the strain point minus 40° C. and at most the strain point plus 70° C., was about 5 minutes in total in each case, and the period of time where the glass plate was held at a temperature of at least the strain point minus 45° C. and at most the strain point plus 70° C., was about 11 minutes in total in each case.

Further, heat treatment of holding the glass plate at 516° C., as a temperature corresponding to the strain point minus 40° C., for 4 hours, was also carried out. In this case, the period of time where the glass plate was held at a temperature of at least the strain point minus 40° C. and at most the strain point plus 70° C., was 0 minute, and the period of time where the glass plate was held at a temperature of at least the strain point minus 45° C. and at most the strain point plus 70° C., was about 1 minute.

With respect to the glass plate subjected to such heat treatment, chemical tempering treatment of immersing it in a KNO₃ molten salt (KNO₃: 100%) at 435° C. for 4 hours was carried out. S and t of the chemically tempered glass were measured. The results are shown in Table 4 together with ΔS. As compared with S=780 MPa of the glass plate not subjected to the heat treatment, an improvement of S by 77 MPa was observed in the case where the heat treatment at 546° C. for 4 hours was carried out. Further, in the case of the glass subjected to the heat treatment at 516° C. as a temperature corresponding to the strain point minus 40° C. for 4 hours, an improvement of S by 43 MPa was observed. On the other hand, in the heat treatment wherein the holding time was 20 minutes, S was 781 MPa, and AS was 1 MPa, and thus no substantial improvement of S was observed.

TABLE 4

| ⊖ | H | S | t | ΔS |
|---|---|---|---|---|
| 546 | 4 | 857 | 38 | 77 |
| 546 | ⅓ | 781 | 43 | 1 |
| 516 | 4 | 823 | 40 | 43 |

### Example 5

Using the same float glass as the one used in Example 4, heat treatment was carried out at θ=546° C. for 240 minutes. Thereafter, the temperature was raised at a rate of 3° C./min., and the glass was held at 616° C., i.e. higher by 60° C. than the strain point, for 60 minutes and then cooled at a cooling rate of 10° C./min. In this case, the period of time where the glass was held at a temperature of at least the strain point minus 40° C. and at most the strain point plus 70° C., was about 340 minutes, and the period of time where the glass plate was held at a temperature of at least the strain point minus 45° C. and at most the strain point plus 70° C., was about 340 minutes. With respect to the obtained glass plate, chemical tempering treatment of immersing it in a KNO₃ molten salt (KNO₃: 100%) at 435° C. for 4 hours was carried out, whereby ΔS=62 MPa.

### INDUSTRIAL APPLICABILITY

The present invention is useful for the production of a chemically tempered glass to be used for a cover glass or substrate for display devices, a substrate for solar cells, a window glass for aircrafts, etc.

This application is a continuation of PCT Application No. PCT/JP2011/078598, filed on Dec. 9, 2011, which is based upon and claims the benefit of priority from Japanese Patent Application No. 2010-275791 filed on Dec. 10, 2010. The contents of those applications are incorporated herein by reference in its entirety.

What is claimed is:

1. A process for producing a chemically tempered glass, which comprises holding a glass at a temperature of at least the strain point minus 40° C. and at most the strain point plus 70° C. for at least 30 minutes for heat treatment, and thereafter, immersing it in a molten salt for ion exchange without allowing the temperature to exceed the strain point plus 70° C.

2. The process for producing a chemically tempered glass according to claim 1, wherein in the heat treatment, the glass is held at a temperature of at least the strain point minus 30° C. and at most the strain point plus 50° C., and after the heat treatment, the glass is immersed in a molten salt for ion exchange without allowing the temperature to exceed the strain point plus 50° C.

3. The process for producing a chemically tempered glass according to claim 1, wherein the surface compressive stress of the chemically tempered glass is at least 550 MPa.

4. The process for producing a chemically tempered glass according to claim 1, wherein the glass is a glass plate produced by a downdraw process or a float process, or one obtained by processing such a glass plate.

5. The process for producing a chemically tempered glass according to claim 1, wherein the thickness of the chemically tempered glass is at most 1.2 mm.

6. The process for producing a chemically tempered glass according to claim 1, wherein the chemically tempered glass is one to be used for a chassis or a cover glass for a display device.

7. The process for producing a chemically tempered glass according to claim 6, wherein the display device is a mobile device, a touch panel or a flat-screen television having a size of at least 20 inches.
